(19) United States
(12) Patent Application Publication
(10) Pub. No.: US 2011/0274785 A1
(43) Pub. Date: Nov. 10, 2011

(54) METHOD AND SYSTEM FOR PRODUCING A MALT BEVERAGE HAVING A HIGH DEGREE OF FERMENTATION

(75) Inventors: Bert Boyce, Cambridge, MA (US); C. James Koch, Newton, MA (US); David Grinnell, Medfield, MA (US); Martin Zarnkow, Munchen (DE)

(73) Assignee: Boston Beer Corporation, Boston, MA (US)

(21) Appl. No.: 13/103,660

(22) Filed: May 9, 2011

Related U.S. Application Data
(60) Provisional application No. 61/333,032, filed on May 10, 2010.

(51) Int. Cl. C12C 7/04; C12C 7/17; C12C 7/165

(52) U.S. Cl. 426/13; 426/16; 99/276

(57) ABSTRACT

Exemplary embodiments of a brewing method and system are provided, where a mixture comprising water and milled malt are mixed to produce a primary mash, and wort is produced from the primary mash. A supernatant liquid is obtained comprising active enzymes from a secondary mash, and the supernatant liquid is added from the secondary mash to the wort, and/or the supernatant liquid can be added to fermented wort after yeast is added to the wort.

### CROSS-REFERENCE TO RELATED APPLICATION

This application claims priority under 35 U.S.C. §119(e) to U.S. Provisional Patent Application Ser. No. 61/333,032, filed on May 10, 2010, the entire disclosure of which are expressly incorporated herein by reference.

### FIELD OF THE DISCLOSURE

The present disclosure relates to exemplary embodiments of methods and systems for producing a malt beverage, and more particularly, to exemplary embodiments of methods and systems for brewing a malt beverage having a high degree of fermentation.

### BACKGROUND INFORMATION

The production of fermented malt beverages, e.g., beer, can involve the following processes: mixing warm water with milled barley malt and potentially additional adjunct cereals, such as corn and/or rice, to obtain a sugar rich solution. The water can activate enzymes present in the malt, which then act on the starch present in the grains to create sugar. This solution can be extracted from the grain and then boiled. Such solution is then cooled and fermented by yeast to create ethanol and carbon dioxide.

Initially, the process of malting barley can involve the steeping, germination, and kilning of raw barley in order to create enzymes, fix their content, and create desirable flavor attributes for brewing. A steeping process can involve mixing of the raw barley with warm water in a steeping vessel in which it can achieve a specific moisture content, such as around 42-47%. The barley is then allowed to germinate and induced by draining water and the introduction of warm air. The time and temperature of the operation can be important, as this is when enzymes are formed at the risk of lost starch material, also known as brewer's extract, with warmer temperatures favoring speed. Then, the barley can be kilned, which reduces the water content to a safe level for storage, stops the germination process and therefore the malting loss, drives off unwanted green flavors, and creates desirable flavors through Maillard reactions.

After milling the malt, the mixture can then be mashed in mash tun 110, as shown in FIG. 1. Mashing is the process by which milled malt is mixed with warm water to dissolve starch and activate the enzymes present in the malt to convert that starch to sugar (maltose). By mixing with between approximately 2.5 to 4 times its own weight in water of about 45° C., the malt will form a thick mash. The mash is then heated in a step-wise to between approximately 63° C. and 70° C., at which point the mash can be allowed to rest for approximately 15 to 90 minutes and the amylolitic enzymes in the malt can convert the starch into sugar. Finally, the mash temperature can be raised to approximately 77° C. in order to slow the enzymes and further reduce the viscosity of the mash, after which the mash can be pumped to the lauter tun 115.

If a brewing adjunct is used, such as corn or rice, they are mashed independently with a small portion of malted barley in mash kettle 105. Adjunct materials can be those that may be used in brewing with the primary function of providing a supplemental source of fermentable carbohydrate, and depending on availability and suitability, such adjuncts may be in the form of whole grain cereals, as the partially refined product of dry milling, as a by-product of cereal processing, as a highly refined product such as that from wet milling, as a concentrated syrup resulting from cereal starch hydrolysis, or as the fermentable sugar itself in a dry form. Because the adjuncts do not have all the enzymes needed to convert their own starch to sugar, the portion of malt enzymes can promote the conversion. However, adjuncts are mashed by raising the entire portion slowly to a boil, using heat to burst the starch molecules. After this conversion has taken place, the adjunct mash is added to the main mash in mash tun 110, where the remaining enzymes degrade the bursted starch prior to moving the entire mash to the lauter tun 115.

The lauter tun 115 is a vessel with a screened false bottom, which facilitates the separation of the sweet liquid, now called wort, from the spent grains. During this process, the wort to be drained through the grain bed and collected in the kettle 120. After the majority of the wort has been collected, additional hot water of approximately 77° C. is sprayed over the top of the grain bed to rinse the trapped residual extract from within the grain and collected in the kettle 120. This process is called sparging.

Following transfer of the wort to the boiling kettle 120, the wort is boiled for up to, e.g., approximately 90 minutes and hops are added. The boiling process can serve several purposes, such as: (a) concentration and sterilization of the wort; (b) extraction and conversion of bittering hop compounds; (c) coagulation of protein; (d) stopping the malt enzymes and fixing the sugar composition of the wort; and (e) driving off of unwanted aromatic compounds.

Following boiling, the wort solids, or “tub,” are separated from the wort via some sort of centrifugal force, either in a vessel known as the whirlpool or through a centrifuge. The wort is then cooled to between approximately 10° C. and 20° C. in heat exchanger 125. Then, air can be injected inline to fermentation vessel 135.

In the fermentation vessel 135, the cooled aerated wort is mixed with yeast from the yeast tank 130 and the fermentation begins. The sugar composition of wort consists largely of maltose and maltotriose, along with small portions of hexoses and sucrose, which are fermentable into ethanol, as well as longer chains of sugar known as dextrins, which are unfermentable. The ratio of fermentable to unfermentable sugar is set during the mashing process, and determines the potential alcohol and the residual sugar contents, which in turn effect the body and caloric contents of the finished beer. The fermentation process often takes approximately 4-8 days, during which time the yeast convert the fermentable sugar into alcohol and carbon dioxide, releasing heat from the reaction into the liquid. Upon completing fermentation, the yeast will flocculate and settle to the bottom of the fermentation vessel 135, while the liquid itself will be cooled to approximately 0° C. to promote complete flocculation. The liquid at the completion of fermentation is now known as beer.

Upon the completion of the fermentation and the subsequent cooling, the beer is transferred to a storage tank 140, and held for approximately 2 to 4 weeks, at approximately 0° C. to 5° C. During this time, the beer undergoes additional settling and clarification, as well as maturation of flavor. At the end of the storage period, the beer is usually filtered bright by filter 145, CO₂ is added at a specified level, which may or may not be flash pasteurized, and is then sent to be packaged at packaging vessel 150.

The beer can then be packaged into packages 155, which can be (but is not limited to) bottles or kegs. Beer packaged in kegs for the draft market is often unpasteurized, while bottled beer is often pasteurized, and may be done so prior to packaging or in the bottle itself. The beer is then labeled, packed, and is ready for distribution.

The traditional brewing process described herein above has been developed and refined over time to yield consistent but ordinary beer. The limits of this process are approached and/or reached when attempting to make a beer with a very low residual extract and a high degree of alcohol, and are commonly obviated by adding either exogenous enzymes or more fully fermentable extract sources such as sugars or adjunct cereals. However, the original version of the “German Purity Law”, also known as the Reinheitsgebot, provides that only water, malted barley, hops, and yeast can be used in the production of beer, thereby forbidding the use of these alternative solutions.

An exemplary mass-based relationship between the amount of sugar in the wort and the concentrations of alcohol and CO₂ produced by fermentation can be linear, and may be represented by the Gay-Lussac formula for alcoholic fermentation as:

C₆H₁₂O₆→2C₂H₅OH+2CO₂

Additionally, the brewer's measure of the progress of this reaction can be referred to as the Real Degree of Fermentation (“RDF”), and is represented as:

RDF, %={[100(O−E)]/O}×{1/[1−(0.005161×E)]},

or, e.g., the difference between the Original Extract less the Final Extract divided by the Original Extract, where O is defined as the original extract and E is defined as the real extract.

Accordingly, in order to increase the alcohol content of the beer, either the Original Extract and/or the RDF must be increased. There can be a natural maximum RDF using the traditional materials that are compliant with the Reinheitsgebot, and so once maximizing the RDF, the only choice to achieve a high alcohol content is to start with a high original gravity.

This ultimately creates a beer with a heavy mouthfeel, high caloric content, and strong induction of satiety.

Thus, there is a need for providing method and systems for brewing beer that can provide such beer with a high alcohol content that is light in body, while honoring and adhering to the German Purity Law, or Reinheitsgebot.

### SUMMARY OF EXEMPLARY EMBODIMENTS OF THE DISCLOSURE

At least some of the above described problems can be addressed by exemplary embodiments of the methods and systems according to the present disclosure.

The present disclosure provides exemplary methods and systems that can facilitate a particular procedure of brewing a high-alcohol content, all-malt beer with a high degree of fermentation. This can be achieved by using, e.g., a secondary mash employing only green malt, in which the mash can be allowed to settle and the supernatant can then be removed, for additions to a kettle and fermentation vessel. This supernatant can contain a large concentration of active enzymes which act to further degrade the starch and sugars present in the mash and fermenting beer, which can create more fermentable sugar in the brewhouse as well as releasing additional sugar into the liquid for fermentation by yeast. This exemplary procedure can achieve a dry, delicate, and highly fermented beer, while adhering strictly to the German Purity Law, meaning that the beer is produced without the use of exogenous enzymes or brewing adjuncts, such as corn or rice.

For example, according to one exemplary embodiment of the present disclosure, a method for producing a malt beverage can be provided, comprising obtaining a mixture comprising water and milled malt to produce a primary mash, producing wort from the primary mash, obtaining a supernatant liquid comprising active enzymes from a secondary mash, and adding the supernatant liquid from the secondary mash to the wort.

The method of can further comprise adding milled green malt to the secondary mash. The milled green malt can comprise a malted cereal that has been steeped, germinated, and then dried. The method can further comprise boiling the wort after adding the supernatant liquid, and adding yeast to the wort for fermentation after the boiling. The method can further comprise cooling the wort to between approximately 10° C. and 20° C. before adding yeast to the wort and after boiling the wort, and adding the supernatant liquid from the secondary mash to the wort after adding yeast to the wort.

The secondary mash can comprise a mash between approximately 60° C. and 65° C. which comprises beta-amylase. The secondary mash can comprise a mash between approximately 55° C. and 60° C. which comprises limit dextrinase. The primary mash can be produced using an infusion procedure. The infusion procedure can be provided at a density of approximately 35 kg/hL, with a protein rest at between approximately 45° C. to 55° C. for approximately 10 to 20 minutes, followed by a saccharification rest at 60° C. to 70° C. for approximately 140 to 160 minutes.

According to another exemplary embodiment of the present disclosure, a method for producing a malt beverage can be provided, comprising mixing a mixture comprising water and milled malt to produce a primary mash, producing wort from the primary mash, adding yeast to ferment the wort, obtaining a supernatant liquid comprising active enzymes from a secondary mash, and adding the supernatant liquid from the secondary mash to the fermented wort.

According to another exemplary embodiment of the present disclosure, a system for brewing a malt beverage can be provided, comprising a mash tun which is structured to facilitate mixing a mixture comprising water and milled malt to produce a primary mash, a wort-producing vessel which is structured to facilitate producing wort from the primary mash, a mash kettle which is structured to facilitate producing a secondary mash, and a distribution arrangement which is structured to provide a supernatant liquid comprising active enzymes from the secondary mash to the wort. The wort-producing vessel can comprise a lauter tun or mash filter.

According to yet another exemplary embodiment of the present disclosure, a system for brewing a malt beverage can be provided, comprising a mash tun which is structured to facilitated mixing a mixture comprising water and milled malt to produce a primary mash, a wort-producing vessel which is structured to facilitate producing wort from the primary mash, a fermenting arrangement which is structured to facilitate adding of yeast to the wort to ferment the wort, a mash kettle arrangement which is structured to facilitate producing a secondary mash, and a distribution arrangement structured to provide supernatant liquid comprising active enzymes from the secondary mash to the fermenting vessel. The wort-producing vessel can comprise a lauter tun or mash filter.

### BRIEF DESCRIPTION OF THE DRAWINGS

The foregoing and other objects of the present disclosure will be apparent upon consideration of the following detailed description, taken in conjunction with the accompanying drawings and claims, in which like reference characters refer to like parts throughout, and in which:

FIG. 1 is a block diagram of a conventional brewing process of beer;

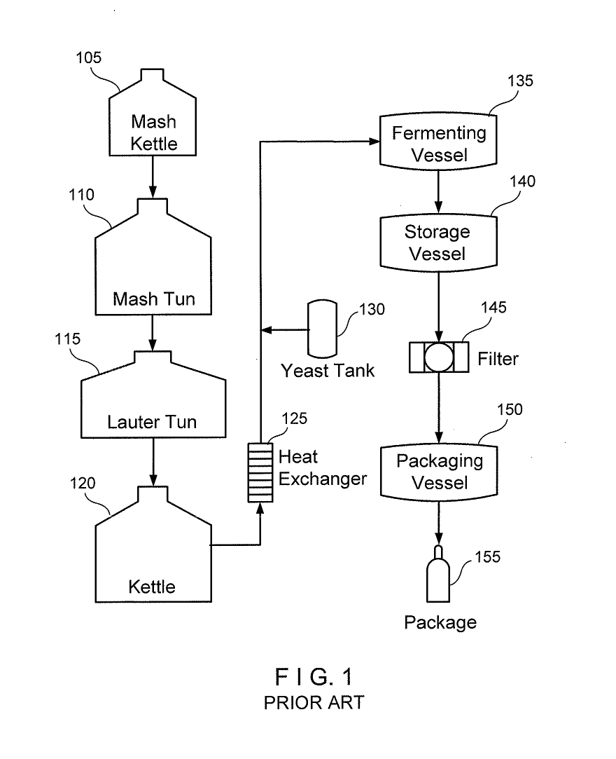

FIG. 2 is a block diagram of a brewing procedure according to an exemplary embodiment of the present disclosure;

FIG. 3 is a block diagram of a brewing procedure according to another exemplary embodiment of the present disclosure;

FIG. 4 is a graph of a mash program according to an exemplary embodiment of the present disclosure which is associated with the exemplary brewing procedure shown in FIGS. 2 and 3; and

FIG. 5 is a flow diagram of a process according to an exemplary embodiment of the present disclosure.

FIG. 6 is a flow diagram of a process according to another exemplary embodiment of the present disclosure.

Throughout the figures, the same reference numerals and characters, unless otherwise stated, are used to denote like features, elements, components or portions of the illustrated embodiments. Moreover, while the subject disclosure will now be described in detail with reference to the figures, it is done so in connection with the illustrative embodiments. It is intended that changes and modifications can be made to the described embodiments without departing from the true scope and spirit of the subject disclosure.

### DETAILED DESCRIPTION OF EXEMPLARY EMBODIMENTS OF DISCLOSURE

Exemplary embodiments of the methods and systems according to the present disclosure will be described herein.

The brewing procedures according to the exemplary embodiments of the present disclosure can facilitate the production of a beer of, e.g., over approximately 10% alcohol by volume (“ABV”), and a RDF of approximately 79%, without the use of exogenous enzymes or brewing adjuncts. It should be understood that the exemplary embodiments of the present disclosure can also facilitate the production of beer at other levels of alcohol and RDF. For example, according to certain exemplary embodiments of the present disclosure it is possible to use a mash program, as well as the utilization of a “green malt” or chit malt, a separate mash to activate enzymes in the malt for an additional amylolitic enzyme concentration, a removal of a liquid supernatant of this secondary mash and addition of this liquid supernatant to the kettle during fill, and/or a removal of the liquid supernatant of this secondary mash and addition of this liquid supernatant to the fermenter. Each subprocedure of the exemplary procedure can provide positive results independently, and can also each be used in combination with one another. When such exemplary subprocedures are combined, a particular beer can be produced in terms of flavor and structure. For example, an all-malt beer produced by a long, intensive mash program according to an exemplary embodiment of the present disclosure, when adding the liquid supernatant from a secondary mash of green malt to the fermenter after the addition of yeast, can yield a beer of over approximately 10% ABV and an RDF of approximately 79%.

Initially, according to one exemplary embodiment of the present disclosure for producing a highly fermented beer, a particular (e.g., long) mash program can be utilized. For example, a step infusion program can be provided at a density of approximately 35 kg/hL, with a protein rest at 50° C. (±1° C.) for approximately 15 minutes, followed by a saccharification rest at 64° C. (±1° C.) for approximately 150 minutes, which can then be followed by mashing off at approximately 72° C. (±1° C.). Such low mash-off temperature can sacrifice a more greatly reduced wort viscosity, in exchange for additional alpha-amylase activity while in a lauter tun and kettle. This additional enzymatic activity can continue to cleave starch into smaller limit dextrins as well as fermentable sugars while running off, while a standard mash-off temperature of approximately 76° C. (±1° C.) can be provided to halt enzyme activity and increase lauter speed.

The use of green malt in an exemplary embodiment of the disclosure can be beneficial in terms of the quantity and quality of enzymes facilitated. Green malt can be, e.g., a malted cereal that has been steeped and germinated in such a manner as to maximize its enzymatic content, and then minimally dried in order to preserve this enzymatic content. Green malt can be produced for its enzyme content rather than its extract content. Raw barley can be selected for its high protein content, and thus, its higher potential enzyme content. The green malt barley can be steeped for a longer time, at a lower temperature, with more air, and to a higher moisture content to promote enzyme formation, at the expense of high malting loss. Such green malt barley can be germinated at lower temperatures, with more air introduced, and for a longer time to promote full and complete modification and enzyme formation, again at the expense of extract, and without gibberellic acid, H₂O₂, or sulfur. Further, the green malt can be very lightly dried, using cooled dry air in order to slow the drying process, and fix the enzyme content without denaturing. Because of such difficult production processes and its poor storage properties, the use and availability of the green malt are rare. However, the green malt offers benefits in terms of enzyme content to the brewery process.

Further, a creation of a separate mash of green malt can provide an appropriate flexibility and a focused isolation of a specific enzyme, which can then be added at whichever point in the brewery process as desired. According to certain exemplary embodiments of the present disclosure, a mash at approximately 60° C. and 65° C., and more specifically at 63° C. favoring beta-amylase and a mash at approximately 55° C. and 60° C., and more approximately 57° C. favoring limit dextrinase can each be more effective when added at a specific point in the brewery process/procedure. Additionally, the mash can contain grain solids as well as liquids, that are known in the art to contribute excessive polyphenols, which themselves can cause problems downstream such as haze instability and harsh astringency. Thus, to overcome these deficiencies, it is possible (according to an exemplary embodiment of the present disclosure) to allow the mash to settle following the initial mixing, and then to remove the enzyme-rich supernatant liquid that has settled on the surface of the mash as the medium, with the option to then add to the brew at whichever point it is determined to be more effective.

Two exemplary process points can be selected as more beneficial recipients of an enzyme addition, and for certain reasons. Indeed, each alone can contribute significantly to the conversion of starch to sugar, and in conjunction offered the greatest speed and efficacy.

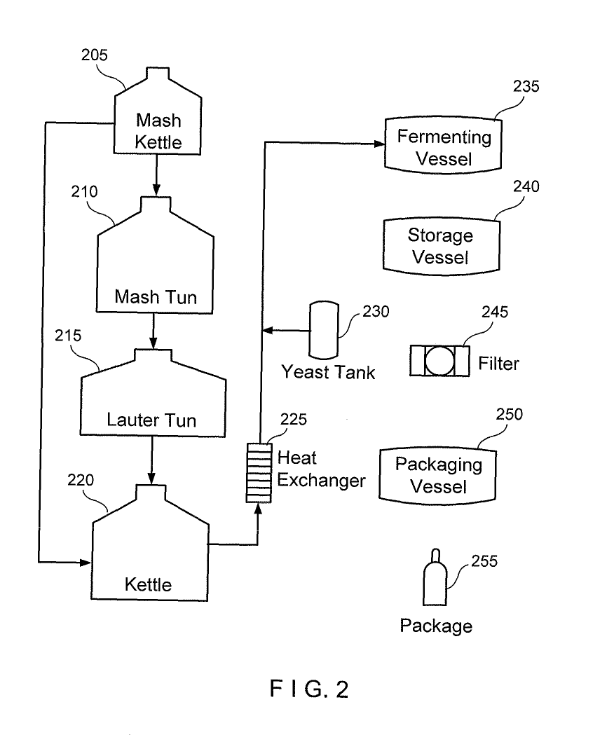

FIG. 2 shows a block diagram of a brewing procedure according to an exemplary embodiment of the present disclosure. According to this exemplary procedure, a first exemplary process point chosen can be an addition to a kettle 220 directly from a mash kettle 205 during fill, after the mixture is received from a mash tun 210 and a wort-producing vessel 215, such as a lauter tun or mash filter. In conjunction with the selected mash program that can favor latent alpha amylase activity in the wort-producing vessel 215 over reduced runoff speed, the supernatant can be added, e.g., shortly after the kettle fill in the mash kettle 220 is started. At approximately 63° C. (±1° C.), the supernatant favors beta-amylase activity, which can assist in the continuation of the breakdown of limit dextrins into additional maltose molecules.

The mixture is then provided to a heat exchanger 225, where it can be cooled, and then forwarded to a fermenting vessel 235, where yeast from a yeast tank 230 is provided for fermentation.

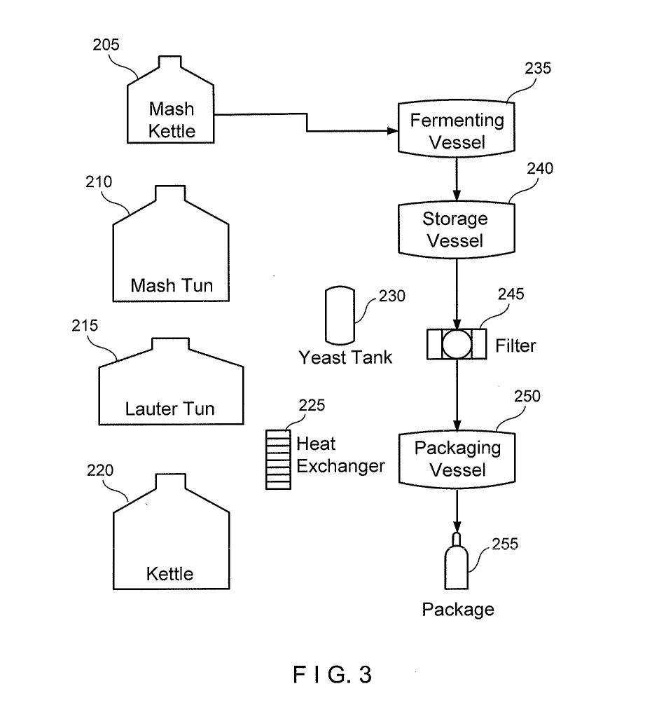

FIG. 3 shows a block diagram of the brewing procedure according to another exemplary embodiment of the present disclosure. In this exemplary embodiment, a second exemplary selected process point can be provided an addition to the fermenter 235 from the mash kettle 205, after complete filling. For example, this addition can be performed at approximately 57° C. (±1° C.), and can favor the activity of limit dextrinase, as well as facilitate significant beta-amylase activity. Limit dextrinase can serve to reduce limit dextrins into amylose, which can then be further degraded by beta-amylase into maltose. While limit dextrinase can be unstable at certain mash temperatures, it is active at fermentation temperature and pH. By adding limit dextrinase to the fermenter 235, it can cause a reduction of limit dextrin that mashing alone likely may not achieve.

The fermenter addition of the supernatant can be beneficial to the brewing process of the highly fermented beer. Indeed, the addition of the supernatant to the fermenter 235 alone can cause a similar reduction of final extract, and it can take longer to perform without the prior action of the addition of the supernatant to the kettle 220. While the fermenter addition alone can eventually break down the limit dextrin to maltose to the maximum extent possible, the prior action in the kettle can reduce the fermenter workload, and speed up the reaction and thus, the overall fermentation speed.

The mixture is then provided to the storage vessel 240, and is filtered by filter 245 and then provided to a packaging vessel 250, where it can be provided in separate packages 255, such as, e.g., a keg or bottle.

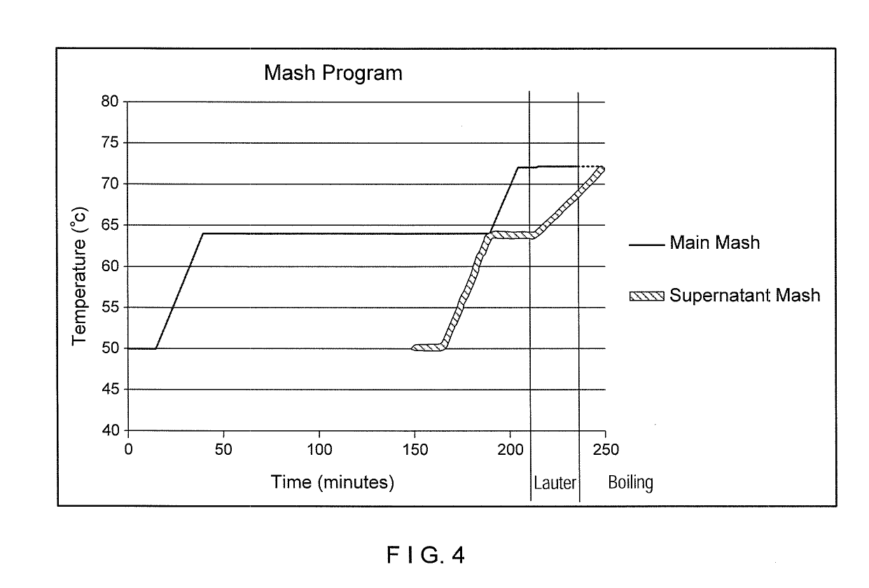

FIG. 4 provides a graph of a mash program that can define the time and temperature program of the primary mash and the addition of the supernatant to the kettle while the wort from the lauter tun is draining to the kettle according to an exemplary embodiment of the present disclosure. As shown by FIG. 4, the secondary supernatant mash can begin much later, and for a shorter time, than the primary mash. It also shows that the temperature of the main mash can remain constant at 72° C. (±1° C.) after mash-off while the temperature of the supernatant increases from 64° C. (±1° C.) to 72° C. (±1° C.) as it meets the liquid from the main mash.

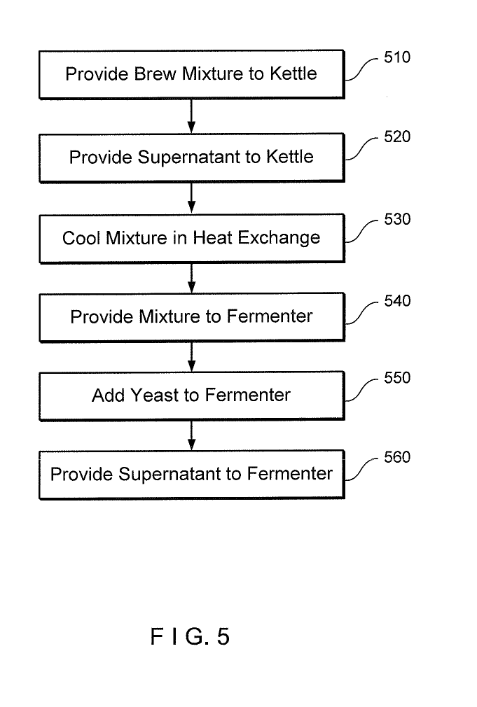

FIG. 5 illustrates a flow diagram of a method of brewing a beer according to an exemplary embodiment of the present disclosure. For example, at block 510, the brew mixture can be provided to a kettle. At block 520, supernatant can be added to the kettle. This can be performed shortly after the kettle fill in the kettle has begun from, e.g., the lauter tun or mash filter. Then, the mixture can be cooled in, e.g., a heat exchanger, at block 530. After cooling, at block 540, the mixture with the supernatant can be provided to the fermenter, where yeast can be added for fermenting the mixture at block 550. A supernatant can then be added to the fermenter at block 560. The supernatant can preferably be added to the fermenter after complete filling of the fermenter, but according to other exemplary embodiments of the present disclosure, it is possible to add the supernatant at other times, e.g., before complete filling.

Various embodiments and specific implementations will now be discussed in accordance with the exemplary embodiments of the present disclosure. Although five exemplary implementations, according to various embodiments of the present disclosure, are described below, numerous examples and different embodiments are possible, as would be known to one of ordinary skill in the art after an understanding of the present disclosure.

In a first exemplary embodiment, a control brew can be provided, using a long mash program, but with no green malt or supernatant additions. A grist bill of about 10% barley malt and about 90% wheat malt can be used, along with a mash program of a step infusion type, in which the grain can be mixed at approximately 50° C., then taken to approximately 62° C. for approximately 110 minutes, followed by approximately 67° C. for approximately 10 minutes, followed by mashing off at approximately 73° C. This fermentation can be performed without any supernatant additions. One set of exemplary results achieved with the first exemplary embodiment is provided in Table 1. As shown in Table 1, a favorable ABV content can be achieved with this exemplary embodiment, and the RDF is in a range to produce a heavy beverage.

TABLE 1

| | |
|---|---|
| COE | 23.6 |
| AE | 4.5 |
| RE | 8.14 |
| ABV | 10.99 |
| ABW | 8.54 |
| RDF | 68.42 |
| pH | 4.36 |
| Time, hrs | 183 |

Other exemplary results of the first exemplary embodiment include a calculated original extract (COE), which can be an amount of extract in ° P at the start of fermentation. AE is the apparent extract, which can be an amount of extract in ° P at the time of the measurement, which can mean the final amount of extract after fermentation, which is not adjusted for the weight of alcohol. RE is the real extract, which can be an amount of extract in ° P at the time of the measurement, which can mean the final amount of extract after fermentation, adjusted for the weight of alcohol. ABV is the alcohol by volume, and ABW is the alcohol by weight. RDF is the real degree of fermentation.

In a second exemplary implementation, according to another exemplary embodiment of the present disclosure, a brew utilizing a long mash program can be provided with the supernatant addition in the kettle but without green malt or fermenter supernatant. A grist bill of about 22% barley malt, about 78% wheat malt can be used with a mash program of a step infusion type, in which the grain can be mixed at approximately 50° C. for approximately 15 minutes, then heated to approximately 63° C. for approximately 150 minutes, followed by mashing off at approximately 72° C. A supernatant addition of about 1% of kettle full volume at approximately 63° C. can then be added to the kettle during filling. The fermentation can be provided for without any supernatant addition. One set of exemplary results achieved with the second exemplary embodiment is provided in Table 2. As shown in this table, a near-favorable RE is achieved, and the RDF and ABV are in a range to produce a light flavor intensity.

TABLE 2

| | |
|---|---|
| COE | 12.8 |
| AE | 1.7 |
| RE | 3.84 |
| ABV | 5.92 |
| ABW | 4.65 |
| RDF | 71.48 |
| pH | 4.23 |
| Time, hrs | 183 |

In a third exemplary implementation, according to another exemplary embodiment of the present disclosure, a brew utilizing a long mash program with both the supernatant additions in the kettle and the fermenter can be provided, and without green malt. A grist bill of about 25% barley malt, about 75% wheat malt can be provided with a mash program of a step infusion type, in which the grain can be mixed at approximately 50° C. for approximately 15 minutes, then heated to approximately 63° C. for approximately 150 minutes, followed by mashing off at approximately 72° C. A supernatant addition of approximately 3% of kettle full volume at approximately 63° C. can be added to the kettle during filling. A second supernatant can be created approximately 24 hours later, at about 8% of fermenter volume, at approximately 57° C., and added to the fermenter. The fermenting can be otherwise normal. One set of exemplary results achieved with the third exemplary embodiment is provided in Table 3. As shown in this table, a favorable ABV is achieved, and the RDF is near-favorable, but the long fermentation time may cause yeast cell autolysis, resulting in an unfavorably high pH.

TABLE 3

| | |
|---|---|
| COE | 19.7 |
| AE | 1.01 |
| RE | 4.56 |
| ABV | 10.38 |
| ABW | 8.17 |
| RDF | 78.76 |
| pH | 4.67 |
| Time, hrs | 304 |

In a fourth exemplary implementation, according to another exemplary embodiment of the present disclosure, a brew utilizing a long mash program with the fermenter supernatant addition and the green malt, but without the kettle supernatant addition can be provided. A grist bill of about 48.3% green malt, about 48.3% wheat malt, and about 3.4% malted oats can be provided with a mash program of a step infusion type, in which the grain can be mixed at approximately 50° C. for approximately 15 minutes, then heated to approximately 63° C. for approximately 150 minutes, followed by mashing off at approximately 72° C. A secondary mash can be created about 24 hours later, and a supernatant at about 8% of fermenter volume, at approximately 57° C., can be removed and added to the fermenter. The ferment can otherwise be normal. One set of exemplary results achieved with the fourth exemplary embodiment is provided in Table 4. As shown in this table, a favorable ABV can be achieved, while the still long fermentation time may cause yeast cell autolysis, resulting in an unfavorably high pH.

TABLE 4

| | |
|---|---|
| COE | 20.5 |
| AE | 0.91 |
| RE | 4.62 |
| ABV | 10.92 |
| ABW | 8.6 |
| RDF | 79.37 |
| pH | 4.58 |
| Time, hrs | 258 |

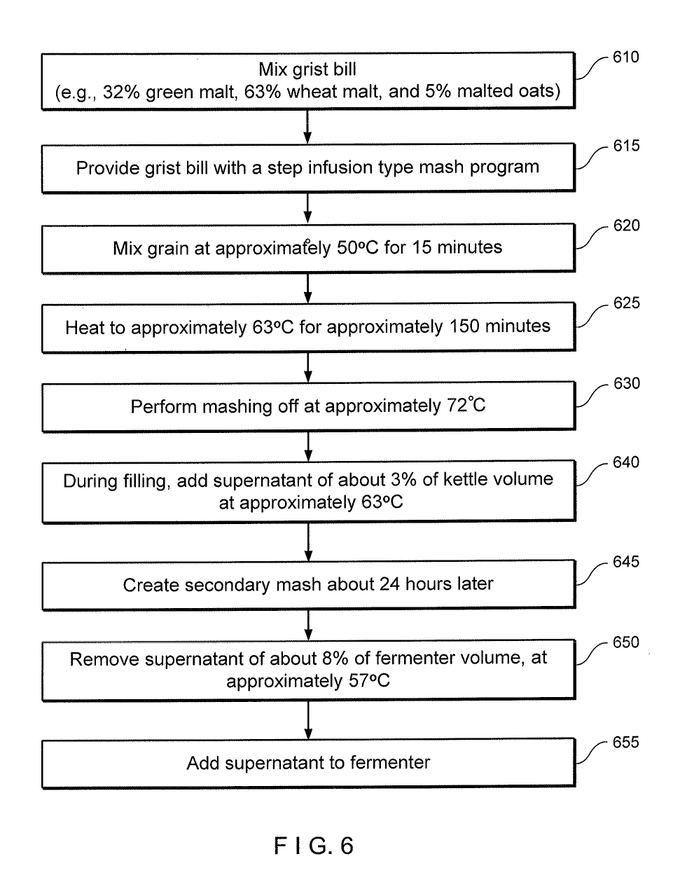

In a fifth exemplary implementation, according to another exemplary embodiment of the present disclosure and illustrated in FIG. 6, a brew utilizing a long mash program with the fermenter and the kettle supernatant additions, along with the green malt can be provided. At procedure 610, a grist bill of about 32% green malt, about 63% wheat malt, and about 5% malted oats can be mixed, and at procedure 615 can be provided with a mash program of a step infusion type. At procedure 620, the grain can be mixed at approximately 50° C. for 15 minutes. Then, at procedure 625, the mixture can be heated to approximately 63° C. for approximately 150 minutes. At procedure 630, mashing off at approximately 72° C. can be performed. At procedure 640, a supernatant addition of about 3% of kettle full volume at approximately 63° C. can be added to the kettle during filling. At procedure 645, a secondary mash can be created 24 hours later, and at procedure 650, a supernatant at about 8% of fermenter volume, at approximately 57° C. can be removed and at procedure 655, added to the fermenter. The fermenting can otherwise be normal. One set of exemplary results achieved with the fifth exemplary embodiment is provided in Table 5. As shown in this table, a favorable ABV, ABW, and RDF can be achieved with acceptable pH levels and fermentation time.

TABLE 5

| | |
|---|---|
| COE | 19.52 |
| AE | 0.88 |
| RE | 4.41 |
| ABV | 10.32 |
| ABW | 8.13 |
| RDF | 79.19 |
| pH | 4.45 |
| Time, hrs | 187 |

Other exemplary embodiments and specific exemplary implementations according to the present disclosure are also possible. Desired values for the parameters discussed above with respect to the exemplary implementations can include, e.g., an ABV≧10.0%, which can provide a basic flavor definition for the malt beverage, a pH≦4.5, which can provide a basic flavor and stability definition for the malted beverage, an optimum time of fermentation of less than 8 days, or 192 hours, which can prevent pH climb due to yeast autolysis, an optimum COE may be the value possible in order to achieve 10.0% ABV, which can be approximately 19.5° P, an optimum RDF can be the maximum achievable, which may be ≧79.0%.

Various other considerations can also be addressed in the exemplary applications described according to the exemplary embodiments of the present disclosure. For example, the supernatant addition can be provided only to the kettle 220, or to the fermenting vessel 235, or both. Different amounts of supernatant can be provided depending on the size of the kettle, size of the fermenting vessel, amount of mixture in the kettle and/or fermenter, etc.

The exemplary embodiments of the present disclosure can be used in various configurations and in different systems. The exemplary methods and systems can provide for uses in various breweries and different processes of brewing.

The foregoing merely illustrates the principles of the disclosure. Various modifications and alterations to the described embodiments will be apparent to those skilled in the art in view of the teachings herein. Further, exemplary embodiments described herein can be used in combination with one another in any combination or procedure thereof. It will thus be appreciated that those skilled in the art will be able to devise numerous systems, arrangements, manufacture and methods which, although not explicitly shown or described herein, embody the principles of the disclosure and are thus within the spirit and scope of the disclosure.

What is claimed is:

1. A method for producing a malt beverage, comprising:
obtaining a mixture comprising water and milled malt to produce a primary mash;
producing wort from the primary mash;
obtaining a supernatant liquid comprising active enzymes from a secondary mash; and
adding the supernatant liquid from the secondary mash to the wort.

2. The method of claim 1, further comprising adding milled green malt to the secondary mash.

3. The method of claim 2, wherein the milled green malt comprises a malted cereal that has been steeped, germinated, and then dried.

4. The method of claim 1, further comprising:
boiling the wort after adding the supernatant liquid; and
adding yeast to the wort for fermentation after the boiling.

5. The method of claim 4, further comprising:
cooling the wort to between approximately 10° C. and 20° C. before adding yeast to the wort and after boiling the wort.

6. The method of claim 4, further comprising:
adding the supernatant liquid from the secondary mash to the wort after adding yeast to the wort.

7. The method of claim 1, wherein the secondary mash comprises a mash between approximately 60° C. and 65° C. which comprises beta-amylase.

8. The method of claim 1, wherein the secondary mash comprises a mash between approximately 55° C. and 60° C. which comprises limit dextrinase.

9. The method of claim 1, wherein the primary mash is produced using an infusion procedure.

10. The method of claim 9, wherein the infusion procedure is provided at a density of approximately 35 kg/hL, with a protein rest at between approximately 45° C. to 55° C. for approximately 10 to 20 minutes, followed by a saccharification rest at 60° C. to 70° C. for approximately 140 to 160 minutes.

11. A method for producing a malt beverage, comprising:
mixing a mixture comprising water and milled malt to produce a primary mash;
producing wort from the primary mash;
adding yeast to ferment the wort;
obtaining a supernatant liquid comprising active enzymes from a secondary mash; and
adding the supernatant liquid from the secondary mash to the fermented wort.

12. The method of claim 11, further comprising adding milled green malt to the secondary mash.

13. The method of claim 12, wherein the milled green malt comprises a malted cereal that has been steeped and germinated, and then dried.

14. The method of claim 11, further comprising:
adding the supernatant liquid to the wort before fermenting the wort.

15. The method of claim 11, wherein the secondary mash comprises a mash between approximately 60° C. and 65° C. which comprises beta-amylase.

16. The method of claim 11, wherein the secondary mash comprises a mash between approximately 55° C. and 60 C which comprises limit dextrinase.

17. The method of claim 11, wherein the primary mash is produced by an infusion procedure.

18. The method of claim 17, wherein the infusion program is provided at a density of approximately 35 kg/hL, with a protein rest at between approximately 45° C. to 55° C. for approximately 10 to 20 minutes, followed by a saccharification rest at 60° C. to 70° C. for approximately 140 to 160 minutes.

19. A system for brewing a malt beverage, comprising:
a mash tun arrangement which is structured to facilitate mixing a mixture comprising water and milled malt to produce a primary mash;
a wort-producing arrangement which is structured to facilitate producing wort from the primary mash;
a mash kettle arrangement which is structured to facilitate producing a secondary mash; and
a distribution arrangement which is structured to provide a supernatant liquid comprising active enzymes from the secondary mash to the wort.

20. The system of claim 19, wherein the wort-producing vessel comprises one of a lauter tun or mash filter.

21. A system for brewing a malt beverage, comprising:
a mash tun arrangement which is structured to facilitated mixing a mixture comprising water and milled malt to produce a primary mash;
a wort-producing arrangement which is structured to facilitate producing wort from the primary mash;
a fermenting arrangement which is structured to facilitate adding of yeast to the wort to ferment the wort;
a mash kettle arrangement which is structured to facilitate producing a secondary mash; and
a distribution arrangement structured to provide supernatant liquid comprising active enzymes from the secondary mash to the fermenting vessel.

22. The system of claim 19, wherein the wort-producing vessel comprises one of a lauter tun or mash filter.
